(19) United States
(12) Patent Application Publication
(10) Pub. No.: US 2007/0221423 A1
(43) Pub. Date: Sep. 27, 2007

(54) Motorized wheel chair whose battery is mounted easily and quickly

(75) Inventor: Feng-Chu Chang, Hsin Chang City (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: CHIENTI ENTERPRISE CO., LTD., Hsin Chang City (TW)

(21) Appl. No.: 11/389,680

(22) Filed: Mar. 27, 2006

(51) Int. Cl. B60R 16/04

(52) U.S. Cl. 180/68.5; 180/907

(57) ABSTRACT

A motorized wheel chair includes a main body having two support rods, a battery mounted between the support rods of the main body, and two rotation retaining members each rotatably mounted on a respective one of the support rods and each rotatable to rest on the battery to retain the battery on the main body. Thus, the user only needs to hang the battery on the support rods, to rotate the rotation retaining members and to press the rotation retaining members on the battery so as to attach the battery to the main body, so that the battery is mounted on the main body easily and conveniently. In addition, the battery is retained by the rotation retaining members, so that the battery is mounted on the main body rigidly and stably.

### BACKGROUND OF THE INVENTION

1. Field of the Invention

The present invention relates to a wheel chair and, more particularly, to a motorized wheel chair.

2. Description of the Related Art

A conventional motorized wheel chair comprises a main body having a seat, an electric power drive device mounted on the main body, and a battery mounted on the main body to supply an electric power to the electric power drive device so as to drive the wheel chair. However, the battery cannot be mounted on and detached from the main body easily and conveniently, thereby causing inconvenience to a user in maintenance and replacement of the battery.

### BRIEF SUMMARY OF THE INVENTION

In accordance with the present invention, there is provided a motorized wheel chair, comprising a main body having a seat and two support rods located under the seat, a battery mounted between and supported by the support rods of the main body, and two rotation retaining members each rotatably mounted on a respective one of the support rods of the main body and each rotatable to rest on the battery to retain the battery on the main body.

The primary objective of the present invention is to provide a motorized wheel chair having a battery that is mounted on and detached from a main body easily, quickly and conveniently, thereby facilitating a user mounting and detaching the battery.

Another objective of the present invention is to provide a motorized wheel chair, wherein the user only needs to hang the elongated slides of the battery on the support rods of the main body, to rotate the rotation retaining members and to press the rotation retaining members on the elongated slides of the battery so as to attach the battery to the main body, so that the battery is mounted on the main body easily and conveniently.

A further objective of the present invention is to provide a motorized wheel chair, wherein the battery is locked on and unlocked from the support rods of the main body by rotating the rotation retaining members, so that the battery is mounted on and detached from the main body easily and quickly.

A further objective of the present invention is to provide a motorized wheel chair, wherein the battery is retained by the rotation retaining members, so that the battery is mounted on the main body rigidly and stably.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a motorized wheel chair in accordance with the preferred embodiment of the present invention.

FIG. 2 is a locally enlarged view of the motorized wheel chair as shown in FIG. 1.

FIG. 3 is a perspective view of a battery of the motorized wheel chair as shown in FIG. 1.

FIG. 4 is a another perspective view of the battery of the motorized wheel chair as shown in FIG. 1.

FIG. 5 is a rear perspective view of the motorized wheel chair as shown in FIG. 1.

FIG. 6 is an exploded perspective view of the motorized wheel chair as shown in FIG. 5.

FIG. 7 is a perspective view of the battery of the motorized wheel chair as shown in FIG. 6.

FIG. 8 is a locally enlarged view of the battery of the motorized wheel chair as shown in FIG. 7.

### DETAILED DESCRIPTION OF THE INVENTION

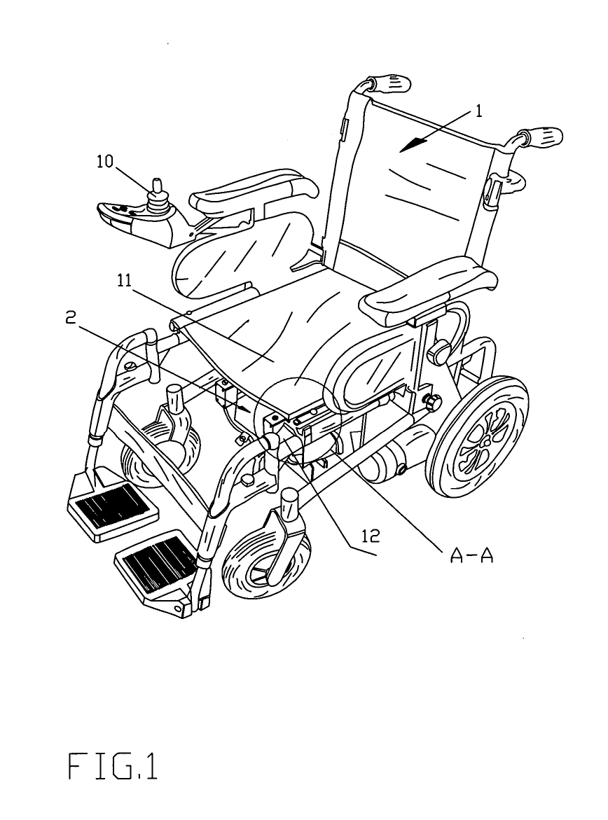

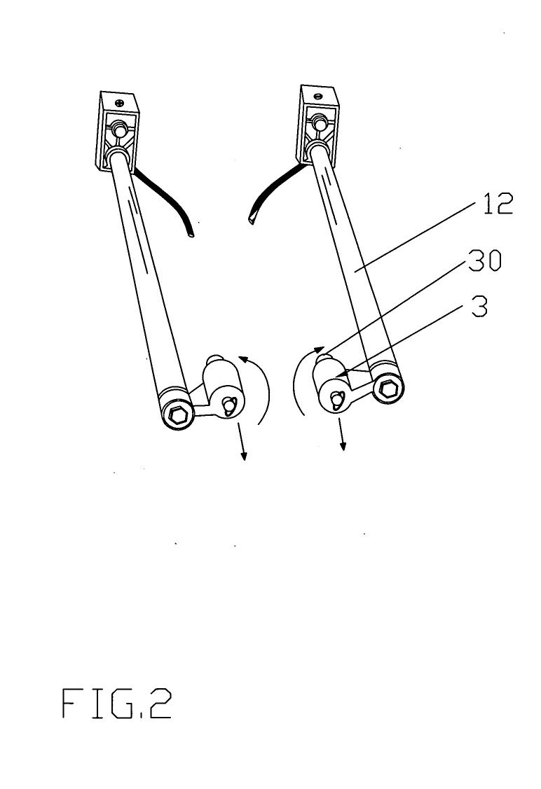

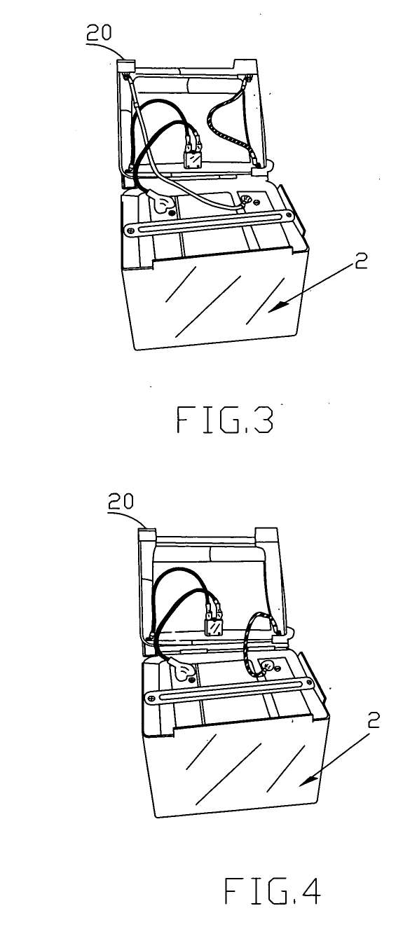

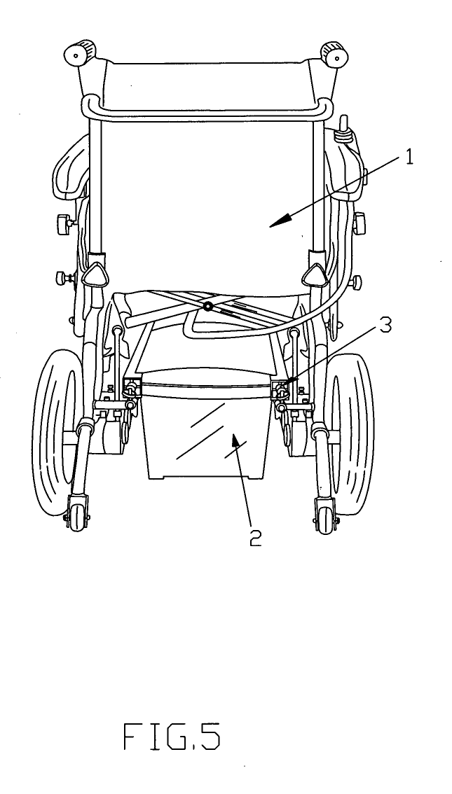

Referring to the drawings and initially to FIGS. 1-5, a motorized wheel chair in accordance with the preferred embodiment of the present invention comprises a main body 1 having a seat 11 and two support rods 12 located under the seat 11, an electric power drive device 10 mounted on the main body 1, a battery 2 mounted between and supported by the support rods 12 of the main body 1, and two rotation retaining members 3 each rotatably mounted on a respective one of the support rods 12 of the main body 1 and each rotatable to rest on the battery 2 to retain the battery 2 on the main body 1.

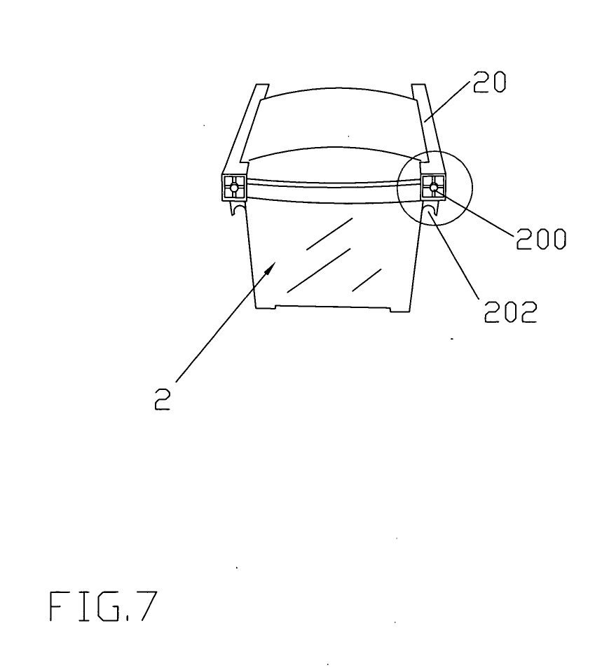

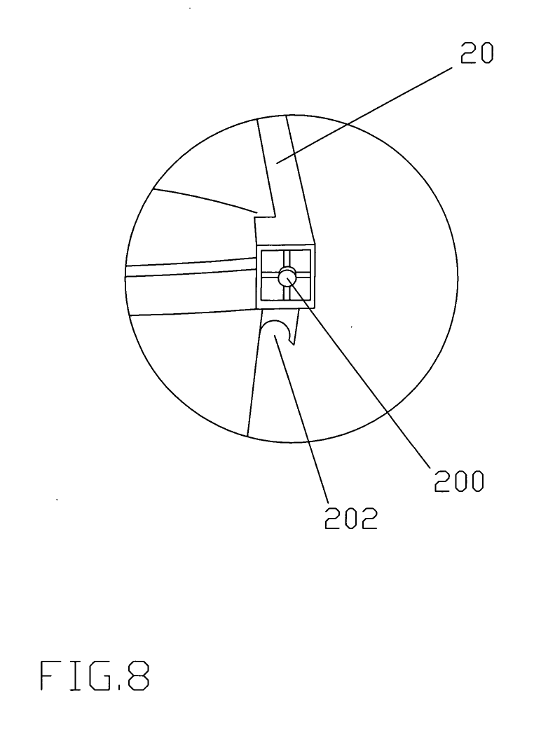

Referring to FIGS. 6-8 with reference to FIGS. 1-5, the battery 2 has two opposite elongated slides 20 each slidably mounted on a respective one of the support rods 12 of the main body 1. The elongated slides 20 of the battery 2 are formed on and protruded outwardly from two opposite sides of the battery 2, and each of the elongated slides 20 of the battery 2 is located at an upper portion of the battery 2. Each of the elongated slides 20 of the battery 2 has a bottom formed with an axially extending substantially arc-shaped slideway 202 slidably mounted on the respective support rod 12 of the main body 1. Each of the elongated slides 20 of the battery 2 has an end portion formed with a snapping hole 200.

Each of the rotation retaining members 3 is rotatably mounted on an end portion of the respective support rod 12 of the main body 1 so that each of the rotation retaining members 3 is rotatable about the respective support rod 12 of the main body 1. Each of the rotation retaining members 3 is rotatable to rest on a respective one of the elongated slides 20 of the battery 2. Each of the rotation retaining members 3 has a side formed with a snapping member 30 that is movable and is snapped into the snapping hole 200 of the respective elongated slide 20 of the battery 2 so that each of the rotation retaining members 3 is snapped onto the respective elongated slide 20 of the battery 2 to retain the battery 2 on the main body 1. After the battery 2 is mounted on the main body 1, the battery 2 is connected to the electric power drive device 10 to supply an electric power to the electric power drive device 10 so as to drive the wheel chair.

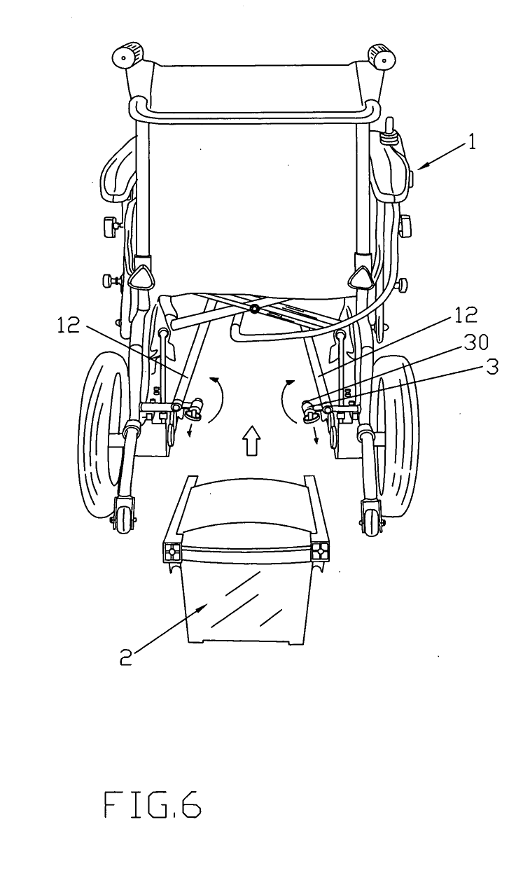

In operation, referring to FIGS. 1-8, each of the rotation retaining members 3 is rotatable outwardly relative to the respective support rod 12 of the main body 1 as shown in FIG. 6. Then, the battery 2 is pushed toward the support rods 12 of the main body 1. At this time, the slideway 202 of each of the elongated slides 20 of the battery 2 is mounted on the respective support rod 12 of the main body 1, so that the battery 2 is supported by the support rods 12 of the main body 1. Then, each of the rotation retaining members 3 is rotatable inwardly relative to the respective support rod 12 of the main body 1 as shown in FIG. 5, so that the snapping member 30 of each of the rotation retaining members 3 is snapped into the snapping hole 200 of the respective elongated slide 20 of the battery 2. Thus, each of the rotation retaining members 3 is snapped onto the respective elongated slide 20 of the battery 2 to retain the battery 2 on the main body 1.

Accordingly, the user only needs to hang the elongated slides 20 of the battery 2 on the support rods 12 of the main body 1, to rotate the rotation retaining members 3 and to press the rotation retaining members 3 on the elongated slides 20 of the battery 2 so as to attach the battery 2 to the main body 1, so that the battery 2 is mounted on the main body 1 easily and conveniently. In addition, the battery 2 is locked on and unlocked from the support rods 12 of the main body 1 by rotating the rotation retaining members 3, so that the battery 2 is mounted on and detached from the main body 1 easily and quickly. Further, the battery 2 is retained by the rotation retaining members 3, so that the battery 2 is mounted on the main body 1 rigidly and stably.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A motorized wheel chair, comprising:
a main body having a seat and two support rods located under the seat;
a battery mounted between and supported by the support rods of the main body;
two rotation retaining members each rotatably mounted on a respective one of the support rods of the main body and each rotatable to rest on the battery to retain the battery on the main body.

2. The motorized wheel chair in accordance with claim 1, wherein the battery has two opposite elongated slides each slidably mounted on a respective one of the support rods of the main body.

3. The motorized wheel chair in accordance with claim 2, wherein the elongated slides of the battery are formed on and protruded outwardly from two opposite sides of the battery.

4. The motorized wheel chair in accordance with claim 2, wherein each of the elongated slides of the battery is located at an upper portion of the battery.

5. The motorized wheel chair in accordance with claim 2, wherein each of the elongated slides of the battery has a bottom formed with an axially extending substantially arc-shaped slideway slidably mounted on the respective support rod of the main body.

6. The motorized wheel chair in accordance with claim 1, wherein each of the rotation retaining members is rotatably mounted on an end portion of the respective support rod of the main body so that each of the rotation retaining members is rotatable about the respective support rod of the main body.

7. The motorized wheel chair in accordance with claim 2, wherein each of the rotation retaining members is rotatable to rest on a respective one of the elongated slides of the battery.

8. The motorized wheel chair in accordance with claim 7, wherein each of the elongated slides of the battery has an end portion formed with a snapping hole, and each of the rotation retaining members has a side formed with a snapping member that is movable and is snapped into the snapping hole of the respective elongated slide of the battery so that each of the rotation retaining members is snapped onto the respective elongated slide of the battery to retain the battery on the main body.

9. The motorized wheel chair in accordance with claim 1, further comprising an electric power drive device mounted on the main body, wherein the battery is connected to the electric power drive device after the battery is mounted on the main body to supply an electric power to the electric power drive device so as to drive the wheel chair.

10. The motorized wheel chair in accordance with claim 1, wherein each of the rotation retaining members is rotatable relative to the respective support rod of the main body.

11. The motorized wheel chair in accordance with claim 1, wherein the battery is locked on and unlocked from the support rods of the main body by rotating the rotation retaining members.
